(19) United States
(12) Patent Application Publication
(10) Pub. No.: US 2008/0013666 A1
(43) Pub. Date: Jan. 17, 2008

(54) Method for in-situ production of hyperstoichiometric oxide fuel

(76) Inventor: Swaminathan Vaidyanathan, San Jose, CA (US)

Correspondence Address: VAIDYANATHAN, SWAMINATHAN, 6663 POMANDER PLACE, SAN JOSE, CA, 95120, US

(21) Appl. No.: 11/624,388

(22) Filed: Jan. 18, 2007

Related U.S. Application Data
(60) Provisional application No. 60/807,508, filed on Jul. 17, 2006.

(51) Int. Cl. G21C 3/00

(52) U.S. Cl. 376/410

(57) ABSTRACT

Method of producing hyperstoichiometric oxide fuel starting from near-stoichiometric composition, in-situ, while operating in a nuclear reactor, comprising a heavy metal fuel oxide such as uranium oxide or plutonium oxide or mixtures thereof and providing effective amounts of a reactant metal oxide, chosen from among bismuth oxide (Bi₂O₃), copper oxide (CuO) or iron oxide (Fe₂O₃) or a mixture thereof, that is predicted to react with the fuel oxide during initial power operation. The reaction will result in hyperstoichiometric fuel that in turn exhibits an increased creep rate and thereby lowers cladding loads from Pellet-Cladding Interaction (PCI), helping to mitigate PCI failures. The oxygen in the fuel in excess of stoichiometric composition reduces the tendency for secondary degradation that occurs under dry hydrogen conditions in case of inadvertent breach of the fuel cladding.

### CROSS-REFERENCE TO RELATED APPLICATIONS

This application claims the benefit of provisional patent application No. 60/807,508, filed Jul. 17, 2006 by the present inventor.

### STATEMENT REGARDING FEDERALLY SPONSORED RESEARCH OR DEVELOPMENT

This work was not supported by federally sponsored research or development

### INCORPORATION-BY-REFERENCE OF MATERIAL SUBMITTED ON A COMPACT DISC

Not Applicable

### BACKGROUND OF THE INVENTION

1. Field of Invention

The invention lies in the field of nuclear fuel technology and relates, more specifically, to its production and subsequent operation in a reactor.

2. Prior Art

Currently, Light Water Reactors (LWR) use enriched uranium oxide (UO₂) or a mixture of uranium and plutonium oxides (U,Pu)O₂ as nuclear fuel. In current practice, the chemical composition of the as-fabricated fuel is very nearly stoichiometric, that is the O:M atomic ratio is close to 2.00, where M signifies the heavy metal content. A hyperstoichiometric fuel, that is a fuel with an O:M ratio >2.00, is preferred for mitigation of certain types of fuel rod failures. Though small quantities of hyperstoichiometric fuel have been fabricated for testing purposes, large-scale commercial fabrication of fuel of this composition has been found to be difficult. Severe problems are encountered in fabricating fuel with a O:M>2.00, as a high oxygen potential has to be maintained during sintering of the fuel pellets and such high oxygen potential is damaging to the heater coil windings of the sintering furnace.

When a LWR fuel rod wherein a heavy metal oxide fuel such as uranium dioxide contained in a zirconium alloy cladding is subject to a power increase, failure could result as a result of a mechanism known as Pellet-Clad Interaction (PCI) failure. A brief summary of PCI failure mechanisms could be found in the article by K. Edsinger and K. Linga Murty, “LWR Pellet-Cladding Interactions: Materials Solutions to SCC” Journal of Metals, Vol. 53, Issue No. 7, July 2001 and a more comprehensive review could be found in the article by B. Cox, “Pellet-Clad Interaction (PCI) Failures of Zirconium Alloy Fuel Cladding—A Review”, Journal of Nuclear Materials, Volume 172, pp 249-292, 1990. The failure is generally recognized to be a result of the combination of high cladding loads that arise during the power increase as the fuel pellet expands in size to a larger extent than the cladding in combination with the deleterious nature of certain fission products released from the fuel to the cladding-fuel interface that promote intergranular stress corrosion cracking or liquid metal embrittlement of the cladding. PCI failure mitigation requires either a high fuel creep rate to lower the cladding load during the power increase, or a barrier liner or coating on the cladding inner surface that resists PCI cracking, or a combination of these two. Mitigation of PCI failure has been attempted using a variety of different ways: (1) by using a nearly pure zirconium liner on the inner surface of the cladding which is resistant to stress corrosion cracking from the specific fission products, found in US patents by Armijo and Coffin, “Nuclear Fuel Element”, U.S. Pat. No. 4,200,492 and U.S. Pat. No. 4,372,817; (2) by providing graphite as a lubricant between the pellet and cladding, found in US patent by Ferrari, “Pellet-clad interaction resistant nuclear fuel element”, U.S. Pat. No. 4,783,311; (3) by adding a glassy silicate additive to the fuel, described in the US patent by Lay, Rosenbaum, Davies and Marlowe, “Nuclear Fuel”, U.S. Pat. No. 4,869,866 to make the fuel softer and creep faster; (4) by using hyperstoichiometric fuel, that is fuel with an Oxygen to Metal ratio (O:M)>2.00, as described by Davies J. H., Hoshi E. V. and Zimmerman D. L., “Ramp test behavior of high O/U fuel”, Journal of Nuclear Materials, 270 (1999) 87-95, as hyperstoichiometric fuel creeps at a faster rate; (5) by doping the fuel with specific dopants such as chromia, which increases the creep rate of the fuel as described by Julien B., Delafoy C., Rebeyrolle V. and Lansiart S., “Performance of advanced fuel product under PCI conditions”, Proceedings of the International meeting on LWR fuel performance, Orlando, Fla., September 2004.

When PCI mitigation is not specifically engineered into the design, it could still be mitigated by adopting power maneuvering constraints. In this case, a slow increase in the rate of power increase is prescribed that in conjunction with fuel creep, limits the pellet-cladding mechanical interaction loads to acceptable levels thereby mitigating failure. An example for this could be seen in the EPRI Report—Product Number 1012915 dated April 2006, “PCI Analyses and Startup Ramp Rate Recommendations for Westinghouse Fuel in Exelon PW's”.

In addition to PCI failure mitigation, an hyperstoichiometric fuel mitigates secondary failure degradation as described in the U.S. Patent by Davies, “Hydride Damage Resistant Fuel Element”, U.S. Pat. No. 5,434,897. When an LWR fuel rod cladding is breached, an oxidation reaction takes place between the ingressed steam and zirconium-based cladding inner surface resulting in a cladding-interior filled with dry hydrogen. Under dry-hydrogen conditions, the hydrogen is rapidly absorbed by the cladding to form massive secondary hydrides which are brittle in nature. Subsequent loading of the cladding leads to a new rupture at these secondary hydrided locations. Mitigation of this type of degradation requires avoiding the dry hydrogen condition that promotes the formation of massive secondary hydrides. Dry hydrogen will react with hyperstoichiometric fuel to produce steam and prevent dry hydrogen conditions.

With hyperstoichiometric fuel therefore, the increase in the creep rate of the fuel lowers the fuel-clad mechanical interaction loads mitigating PCI failure; at the same time hyperstoichiometric fuel will react with hydrogen preventing dry hydrogen conditions to mitigate secondary degradation.

An alternate means for secondary failure degradation mitigation using the employment of metal oxide powders has been proposed by Vaidyanathan, Davies and Wisner, “Zirconium-alloy cladfuel rods containing metal oxide for mitigation of secondary hydriding”, U.S. Pat. No. 6,697,450, however, this patent purports a direct reaction between selected metal oxides and dry hydrogen to mitigate secondary failure degradation rather than between the hydrogen and hyperstoichiometric fuel. Further, this patent includes a number of metal oxides such as oxides of nickel, tin, chromium and manganese that will not be reduced by stoichiometric UO₂ fuel at typical fuel operating temperatures though they will be reduced by dry hydrogen.

The present invention solves the problems encountered in the fabrication of hyperstoichiometric fuel by utilizing near-stoichiometric fuel as is the current fabrication practice and subsequently modifying its composition, in-situ, during initial power operation in a reactor, by reaction with a reactant metal oxide to produce hyperstoichiometric fuel.

### BRIEF SUMMARY OF THE INVENTION

By the proposed invention, oxide nuclear fuel that is initially of a near-stoichiometric composition is converted, in-situ, during initial power operation in a reactor, to a hyperstoichiometric composition. Fuel of hyperstoichiometric composition is useful in effecting improved fuel performance by mitigation of potential fuel rod failure mechanisms.

It has now been discovered that stoichiometric heavy metal oxide fuels such as uranium dioxide or plutonium dioxide or mixtures thereof, currently used for LWR applications, can be elevated in their oxygen content and made hyperstoichiometric, in-situ, during initial power operation by incorporating suitable reactant metal oxides and by elevating the fuel temperature to required levels for short pre-determined periods of time. A keen understanding of a number of underlying mechanisms is needed to predict which reactant metal oxides are suitable for this purpose; to ascertain if the oxygen diffusion kinetics into the interior of the fuel from the resulting reaction will be sufficiently rapid for elevating the fuel oxygen potential; and to prescribe the amount of reactant metal oxide needed to elevate the fuel oxygen potential to the desired extent.

In a first aspect, the invention provides a method of producing hyperstoichiometric oxide fuel, in-situ, while the fuel is operating at power in the reactor, comprising the step of providing an effective amount of a reactant metal oxide chosen from among Bi₂O₃, CuO and Fe₂O₃ in the fuel rod, emplaced between fuel pellets. The thermodynamic property that determines whether these reactant metal oxides will react with oxide fuel of stoichiometric composition is the free energy of formation which is higher for the chosen reactant metal oxides than for the heavy metal fuel oxide. As a result a reaction will take place between the reactant metal oxide and heavy metal oxide such as stoichiometric UO₂, reducing the reactant oxide to either pure metal or a lower oxide while making the fuel hyperstoichiometric. Based on a comparison of the free energy of formation of the chosen reactant metal oxide, reduction of the reactant metal oxide and elevation of the oxygen content in the fuel oxide is predicted to continue at least until the center of the fuel pellet reaches a chemical composition of UO_{2.04}. For urania fuel of composition UO_{2.04} for example, operating at a temperature between 750° C. and 1000° C., the free energy of formation is seen to be between −225 kJ/mol and −213 kJ/mol. By comparison, the free energy of formation for the chosen reactant metal oxides over the same temperature range are: for bismuth oxide −195 kJ/mol to −148 kJ/mol, for copper oxide (CuO) −131 kJ/mol to −91 kJ/mol, and for hematite (Fe₂O₃) −210 kJ/mol to −140 kJ/mol, considerably higher than for UO_{2.04}. Therefore these reactant metal oxides will be reduced while the O:M of the uranium oxide fuel will be elevated to beyond 2.04 making it hyperstoichiometric, provided sufficient quantities of reactant metal oxides had been incorporated.

While initially the reaction takes place at the interface between the fuel pellet and the reactant metal oxide, continued reaction requires that the oxygen transferred from the reactant oxide to the fuel oxide be further transported to the interior of the fuel pellet. This will happen by diffusion of oxygen from the reaction surface to the interior of the fuel. For this transport to happen in an efficient manner, the reactant metal oxide has to be placed at sufficiently close intervals. In the proposed design, reactant metal oxide is emplaced at fuel pellet intervals and the distance to which the oxygen has to be transported is typically less than 1 cm. The chemical diffusion coefficient, D, for oxygen in urania has been reported as 5.9×10⁻⁶ cm²/sec at 1000° C. and 3.7×10⁻⁷ cm²/sec at 750° C. An assessment for the distance to which the oxygen will penetrate into the fuel can be obtained by using the formula (Dt)^{0.5} where t is the time in seconds. In a month's time, the range of distance to which the oxygen will spread out is on the order of 4 cm at 1000° C. and 1 cm at 750° C. It is therefore predicted that the reactant will be reduced and the oxygen redistributed within the fuel central region within a month of operation in the reactor. Typically, the fuel center temperatures at start-of-life, even for fuel which is operated at low power levels, is higher than 750° C. Therefore it is preferred that the reactant metal oxide be placed at intervals of 1 cm.

Of the three reactant metal oxides chosen, Bi₂O₃ is the preferred reactant metal oxide. Upon reaction, the reactant metal oxide at the interface is reduced and further progress of the reaction is dependent not only on the transport of the oxygen from the interface to the interior of the fuel pellet, but also by the rate at which the oxygen can be transported from the unreacted portion of the reactant metal oxide to the reaction interface. This again will occur by diffusion. In the case of bismuth oxide, once reduction to bismuth had taken place, bismuth will be in a liquid state as its melting point is only 544K, well below the fuel temperature. The presence of the liquid bismuth phase will aid in transport of oxygen from unreacted reactant oxide to the interface.

In a second aspect, the invention provides a means of increasing the fuel creep rate as a result of the conversion of the fuel to a hyperstoichiometric state which lowers cladding loads during fuel Pellet-Cladding mechanical Interaction (PCI). This mitigates or reduces the tendency for PCI failures during power increases.

In a further aspect, the invention provides a fuel rod with reduced tendency to undergo secondary hydriding in case of inadvertent breach of cladding. Dry hydrogen will react with hyperstoichiometric fuel producing steam which passivates the cladding and reduces the tendency for formation of massive secondary hydrides.

### BRIEF DESCRIPTION OF THE SEVERAL VIEWS OF THE DRAWING(S)

FIG. 1 is a typical arrangement of a nuclear fuel rod cross-section comprising oxide fuel pellets and reactant metal oxide contained in a zirconium alloy cladding. The cladding could be of a zirconium based alloy or a composite cladding with an inner zirconium liner. The nuclear oxide fuel is composed of urania or a mixture of urania and plutonia is present in the form of a sintered pellet. The reactant metal oxide is emplaced at the interpellet locations.

FIG. 2 is a typical arrangement of a nuclear fuel rod cross-section comprising dished-ended oxide fuel pellets and reactant metal oxide contained in a zirconium alloy cladding. The cladding could be of a zirconium based alloy or a composite cladding with an inner zirconium liner. The nuclear oxide fuel is composed of urania or a mixture of urania and plutonia is present in the form of a sintered pellet. The reactant metal oxide is emplaced at the interpellet locations in the dished spaces between pellets.

### DRAWINGS—REFERENCE NUMERALS

10 Oxide fuel pellet

20 Cladding

30 Reactant metal oxide

### DESCRIPTION OF THE INVENTION

The present invention resides in the discovery that oxide nuclear fuels of near-stoichiometric composition can be made hyperstoichiometric during operation in the nuclear reactor by reaction between the nuclear fuel and selected reactant metal oxides. The reactant metal oxide is chosen from among the oxides of iron, bismuth, or copper or is a combination of such oxides. The invention finds particular application to uranium oxide fuel contained within zirconium-alloy based cladding. Such fuel rods are commonly employed in Light Water Reactors (LWR).

The reaction is described as follows:

UO_{2.00}+MO_{y}=UO₂₊ₓ+M,

where M represents the reactant metal oxide. The value of x will be determined by the number of moles of oxide fuel that is reacted with the number of moles of reactant metal oxide available for reaction. As the fuel oxide is reacted at the reaction surface to become hyperstoichiometric, oxygen will diffuse to the interior of the pellet. Depending upon the temperature gradients within the fuel pellet, there will arise a concomitant oxygen composition gradient. The reaction will go forward until an equilibrium is established within the fuel pellet and at the reaction surface. It is to be noted that in some instances the reactant metal oxide could be partially reduced to a lower oxide rather than pure metal. For example while it is expected that Bi₂O₃ and CuO will be reduced to their pure metal states, Fe₂O₃ could be reduced to Fe₃O₄ rather than pure Fe.

The physical location of the reactant metal oxide should be such as to facilitate reaction with the fuel pellet. To facilitate reaction, the reactant metal oxide should be in physical contact with the fuel pellet. It should further be placed at sufficiently close intervals so that the oxygen can diffuse into the interior of the pellet from the reaction surface in reasonable time. Based on the diffusion coefficient of oxygen in UO₂ and an expected pellet temperature in the range of 750° C. to 1000° C., the reactant oxide should be placed at intervals not exceeding 10 cm, preferably not exceeding 4 cm.

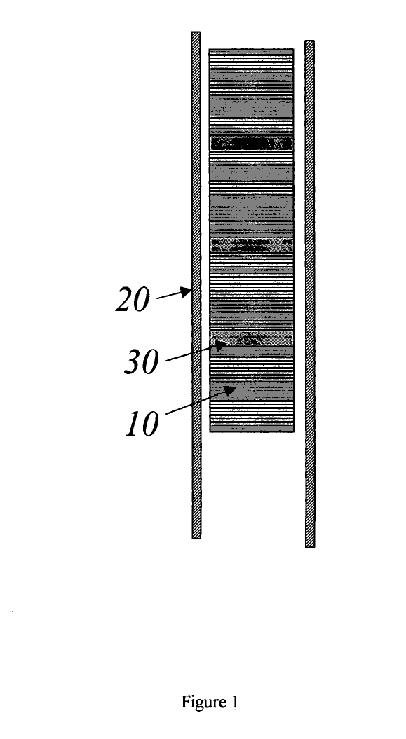

As a first embodiment, reference is made to the accompanying FIG. 1 showing the reactant metal oxide to be present as individual pellets or as wafers and emplaced between fuel pellets. Generally, the individual pellets or wafers will be of nearly the same geometry (diameter) as the pellet. The pellets or wafers are generally fabricated by sintering the reactant metal oxide powder selected from iron oxides (Fe₂O₃), copper oxide

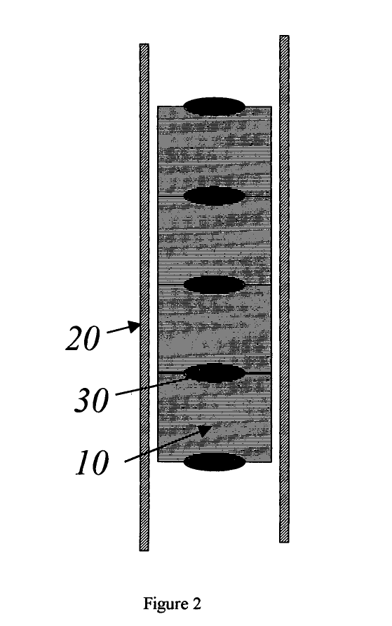

As a second embodiment, reference is made to the accompanying FIG. 2 showing the reactant metal oxide to be shaped to occupy the dished space at pellet ends. Dished oxide fuel pellets are commonly used in LWR fuel rods and the reactant metal oxide is shaped so that its surface could conform to the dish shape and allow for good contact between the fuel pellet and the reactant oxide.

In a third embodiment, the reactant metal oxide is present in the form of a compacted powder rather than as a sintered body.

In a fourth embodiment, the ends of the fuel pellets present a cavity of a convenient shape such as a cylinder or hemisphere and the reactant metal oxide is fabricated to be of a shape that can fit in with this cavity.

In a fifth embodiment, the end surfaces of the fuel pellet are grooved to present a larger surface area for reaction between the fuel oxide and the reactant metal oxide.

The weight of the reactant metal oxide placed between pellets expressed as a fraction of the adjoining fuel pellet weight could range up to 0.12 for Bi₂O₃, 0.06 for CuO and 0.04 for Fe₂O₃.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of producing hyperstoichiometric oxide nuclear fuel, in-situ, while the fuel is resident and operating at power in a reactor core, which comprises the step of providing an effective amount of a reactant metal oxide.

2. A method according to claim 1, wherein said reactant metal oxide is bismuth oxide of the composition Bi₂O₃.

3. The method whereby said reactant bismuth oxide in claim 2 is present in an amount up to 12% of the weight of the fuel oxide.

4. A method according to claim 1, wherein said reactant metal oxide is copper oxide of the composition CuO.

5. The method whereby said reactant copper oxide in claim 4 is present in an amount up to 6% of the weight of the fuel oxide.

6. A method according to claim 1, wherein said reactant metal oxide is iron oxide of the composition Fe₂O₃.

7. The method whereby said reactant iron oxide in claim 6 is present in an amount up to 4% of the weight of the fuel oxide.

8. A method according to claim 1, wherein said reactant metal oxide is a combination of the reactant metal oxides cited in claims 2, 4 and 6.

9. A method wherein said reactant metal oxide of claim 1 is emplaced between pellets.

10. A method wherein said reactant metal oxide of claim 1 is present in the form of a sintered body in the form of a pellet.

11. A method wherein said reactant metal oxide of claim 1 is present in the form of a sintered body in the form of a wafer.

12. A method wherein said reactant metal oxide of claim 1 is coated on to the axial end surfaces of the fuel pellets.

13. A method wherein said reactant metal oxide of claim 1 is a sintered body of a shape that will fit the end of a dished fuel pellet.

14. A method wherein said oxide nuclear fuel of claim 1 is in the form of a pellet with a cavity on its end surfaces.

15. A method wherein said reactant metal oxide of claim 1 is a sintered body of a shape that will fit into said cavity of claim 14.

16. A method wherein said reactant metal oxide of claim 1 is present as a powder.

17. A method wherein said oxide nuclear fuel is in the form of an annular pellet and said reactant metal oxide of claim 1 is emplaced in the central annulus of the annular pellet.

18. A method wherein said oxide nuclear fuel pellet is in the form of a pellet whose end surfaces are grooved.

19. A fuel rod fabricated according to the method of claim 1 wherein said oxide nuclear fuel is uranium oxide.

20. A fuel rod fabricated according to the method of claim 1 wherein said oxide nuclear fuel is a mixed uranium, plutonium oxide.

21. A fuel rod fabricated according to the method of claim 1.
